(19) United States
(12) Patent Application Publication
(10) Pub. No.: US 2013/0130402 A1
(43) Pub. Date: May 23, 2013

(54) FLUORESCENT COMPOUNDS, COMPOSITIONS, AND METHODS FOR USING THE COMPOUNDS AND COMPOSITIONS

(71) Applicants: Michael W. Reed, Lake Forest Park, WA (US); Robert O. Dempcy, Kirkland, WA (US)

(72) Inventors: Michael W. Reed, Lake Forest Park, WA (US); Robert O. Dempcy, Kirkland, WA (US)

(73) Assignee: BLOOD CELL STORAGE, INC., Seattle, WA (US)

(21) Appl. No.: 13/478,071

(22) Filed: May 22, 2012

Related U.S. Application Data
(63) Continuation-in-part of application No. 11/789,431, filed on Apr. 23, 2007.
Application No. 11/789,431 is a continuation-in-part of application No. 11/207,580, filed on Aug. 19, 2005, now Pat. No. 7,608,460.
Application No. 11/207,580 is a continuation-in-part of application No. 12/480,574, filed on Jun. 8, 2009, now Pat. No. 8,183,052.
Application No. 12/480,574 is a continuation-in-part of application No. 11/207,580, filed on Aug. 19, 2005, now Pat. No. 7,608,460.
(60) Provisional application No. 61/491,087, filed on May 27, 2011.
(60) Provisional application No. 60/794,193, filed on Apr. 21, 2006.
(60) Provisional application No. 60/602,684, filed on Aug. 19, 2004.
(60) Provisional application No. 60/674,393, filed on Apr. 22, 2005.
(60) Provisional application No. 61/059,690, filed on Jun. 6, 2008.
(60) Provisional application No. 60/602,684, filed on Aug. 19, 2004.
(60) Provisional application No. 60/674,393, filed on Apr. 22, 2005.

(51) Int. Cl. G01N 21/64

(52) U.S. Cl. CPC G01N 21/6486
USPC 436/501; 549/224; 536/24.3

(57) ABSTRACT

Low pKa fluorescent compounds, compositions that include the compounds, bioconjugates made from the compounds, and methods for making and using the compounds and bioconjugates.

### CROSS-REFERENCES TO RELATED APPLICATIONS

This application claims the benefit of U.S. Patent Application No. 61/491,087, filed May 27, 2011; is a continuation-in-part of U.S. patent application Ser. No. 11/789,431, filed Apr. 23, 2007, which claims the benefit of U.S. Patent Application No. 60/794,193, filed Apr. 21, 2006, and is a continuation-in-part of U.S. patent application Ser. No. 11/207,580, filed Aug. 19, 2005, now U.S. Pat. No. 7,608,460, which claims the benefit of U.S. Provisional Application No. 60/602,684, filed Aug. 19, 2004, and U.S. Provisional Application No. 60/674,393, filed Apr. 22, 2005; and is a continuation-in-part of U.S. patent application Ser. No. 12/480,574, filed Jun. 8, 2009, now U.S. Pat. No. 8,183,052, which claims the benefit of U.S. Provisional Application No. 61/059,690, filed Jun. 6, 2008, and is a continuation-in-part of U.S. patent application Ser. No. 11/207,580, filed Aug. 19, 2005, now U.S. Pat. No. 7,608,460, which claims the benefit of U.S. Provisional Application No. 60/602,684, filed Aug. 19, 2004, and U.S. Provisional Application No. 60/674,393, filed Apr. 22, 2005, each application expressly incorporated herein by reference in its entirety.

### BACKGROUND OF THE INVENTION

Seminaphthofluorescein (SNFL) dyes and seminaphthorhodamine (SNRF) dyes are well-known compounds and commercially available with linker arms that allow their attachment to biomolecules or solid supports. The SNFL dyes are fluorescent and predominately used as pH sensitive dyes due to the spectral properties of the acid and base forms of the dyes as shown below.

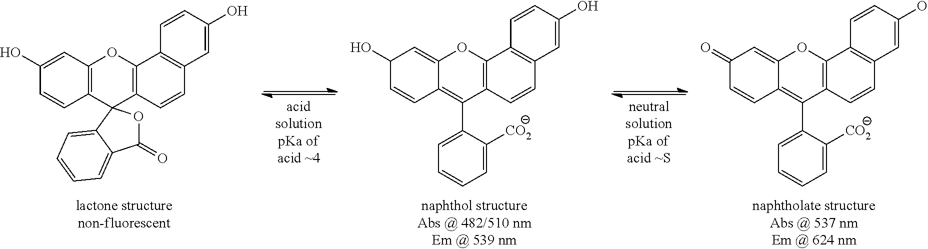

The protonated naphthol form of unsubstituted SNFL (absorbance=482/510 nm, emission=539 nm) predominates at pH below the pKa of 7.8. The deprotonated naphtholate form of SNFL (absorbance=537 nm, emission=624 nm) predominates at pH above the pKa. There is a large difference between the excitation and emission (Stokes shift). The predominant use of SNFL dyes takes advantage of the distinct spectral properties of the naphthol and naphtholate forms of the dyes. For example, the fluorescence spectra of unsubstituted SNFL changes with pH as shown in FIG. 1. Referring to FIG. 1, the 620 nm fluorescence is sensitive to changes in pH range of 7-9, but much less sensitive below pH 7. FIG. 1 demonstrates that SNFL dyes are most sensitive within +/−1 pH unit of the pKa.

Recently 2-chloro-substituted SNFL dyes were found to have surprisingly low pKa in comparison to the previously studied SNFL analogs. Synthesis and characterization of SNFL analogs was reported in 1991 by Whitaker et al. of Molecular Probes Inc. (Anal. Biochem. 194, 330-344). Five derivatives were observed to have a pKa range of 7.63-8.07. The use of a 2-chloro SNFL compound as a fluorescent probe in a pH reading blood bag is described in U.S. Pat. No. 7,608,460.

Despite the advances in the development of fluorescent compounds, a need exists for new fluorescent compounds having advantageous pH-sensitive and fluorescence properties. The present invention seeks to fulfill this need and provides further related advantages.

### SUMMARY OF THE INVENTION

The present invention provides low pKa fluorescent compounds (seminaphthofluorescein (SNFL) and seminaphthorhodamine (SNRF) compounds), compositions that include the compounds, bioconjugates made from the compounds, methods for making the compounds, and methods for using the compounds.

In one aspect, low pKa fluorescent compounds are provided. In one embodiment, the compounds have the formula:

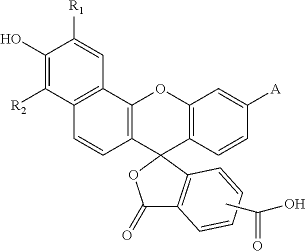

or its active esters, acid/base forms, tautomers, or salts, wherein R₁ is halo and R₂ is hydrogen or halo, and wherein A is OH or N(Rₐ)(R_{b}), wherein Rₐ and R_{b} are independently selected from hydrogen and C1-C6 alkyl. In one embodiment, R₁ is chloro and R₂ is hydrogen. In one embodiment, R₁ is chloro and R₂ is chloro. In one embodiment, A is OH. In another embodiment, A is N(CH₃)₂.

In another embodiment, active esters of the above compounds are provided having the formula:

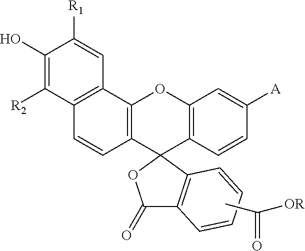

or its acid/base forms, tautomers, or salts, wherein R₁ is halo and R₂ is hydrogen or halo, wherein OR is a leaving group, and wherein A is OH or N(Rₐ)(R_{b}), wherein Rₐ and R_{b} are independently selected from hydrogen and C1-C6 alkyl. In one embodiment, R₁ is chloro and R₂ is hydrogen. In one embodiment, R₁ is chloro and R₂ is chloro. In one embodiment, A is OH. In another embodiment, A is N(CH₃)₂. Suitable R groups include substituted and unsubstituted C1-C12 alkyl groups and substituted and unsubstituted C6-C10 aryl groups. In one embodiment, the active ester is an N-hydroxysuccinimide ester (i.e., R is —N[(C═O)CH₂CH₂(C═O)].

In another embodiment, conjugates prepared from a compound as defined above and a suitably reactive macromolecule are provided. Representative macromolecules include proteins, polypeptides, peptides, and nucleic acids.

In another embodiment, nucleic acid probes prepared from a compound as defined above and a suitably reactive oligonucleotide are provided. In one embodiment, the probe further comprises a second fluorescent compound. In one embodiment, the second fluorescent compound has an emission spectrum that overlaps with the absorption spectrum of the compound defined above. In one embodiment, the second fluorescent compound has an absorption spectrum that overlaps with the emission spectrum of the compound defined above. In one embodiment, the probe comprises a quencher moiety.

In another embodiment, phosphoramidites prepared from a compound as defined above are provided.

In another embodiment, the invention provides a method for determining the presence and/or amount of a nucleic acid in a sample. In a representative method, a sample optionally containing a target nucleic acid is contacted with a nucleic acid probe as defined above capable of hybridizing to the target nucleic acid. In one embodiment, the probe is a hybridization probe. In one embodiment, the probe is a hydrolysis probe.

In another embodiment, the invention provides a kit comprising one or more nucleic acid probes defined above. In one embodiment, the probe is a hybridization probe. In one embodiment, the probe is a hydrolysis probe.

In another embodiment, the invention provides a composition comprising a compound defined above and one or more other fluorescent compounds. In one embodiment, the fluorescent compound is a seminaphthofluorescein.

In another aspect, further methods, kits, and compositions are provided.

In one embodiment, the invention provides a method for determining the presence and/or amount of a nucleic acid in a sample, comprising contacting a sample optionally containing a target nucleic acid with a probe prepared from a suitably reactive oligonucleotide capable of hybridizing to the target nucleic acid and a compound having the formula:

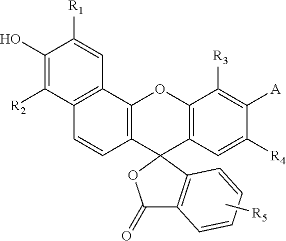

or its active esters, acid/base forms, tautomers, or salts, wherein

R₁ is selected from halo, C₁-C₆ alkyl, C₁-C₆ haloalkyl, and C₁-C₆ alkoxy;

R₂ is selected from hydrogen, halo, C₁-C₆ alkyl, C₁-C₆ haloalkyl, and C₁-C₆ alkoxy;

R₃ is selected from hydrogen, halo, C₁-C₆ alkyl, C₁-C₆ haloalkyl, and C₁-C₆ alkoxy;

R₄ is selected from hydrogen, halo, C₁-C₆ alkyl, C₁-C₆ haloalkyl, and C₁-C₆ alkoxy, and —(CH₂)ₙCO₂H, where n is 1-3, and

R₅ is selected from hydrogen and CO₂H,

provided that at least one of R₄ and R₅ is —(CH₂)ₙCO₂H or CO₂H, respectively, and

A is OH or N(Rₐ)(R_{b}), wherein Rₐ and R_{b} are independently selected from hydrogen and C₁-C₆ alkyl.

In one embodiment, the probe is a hybridization probe. In one embodiment, the probe is a hydrolysis probe.

In another embodiment, the invention provides a kit, comprising one or more nucleic acid probes prepared from a suitably reactive oligonucleotide and a compound having the formula:

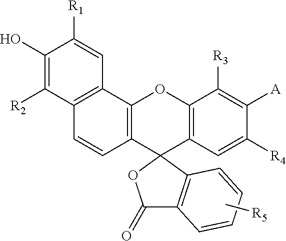

or its active esters, acid/base forms, tautomers, or salts, wherein

R₁ is selected from halo, C₁-C₆ alkyl, C₁-C₆ haloalkyl, and C₁-C₆ alkoxy;

R₂ is selected from hydrogen, halo, C₁-C₆ alkyl, C₁-C₆ haloalkyl, and C₁-C₆ alkoxy;

R₃ is selected from hydrogen, halo, C₁-C₆ alkyl, C₁-C₆ haloalkyl, and C₁-C₆ alkoxy;

R₄ is selected from hydrogen, halo, C₁-C₆ alkyl, C₁-C₆ haloalkyl, and C₁-C₆ alkoxy, and —(CH₂)ₙCO₂H, where n is 1-3, and

R₅ is selected from hydrogen and CO₂H,

provided that at least one of R₄ and R₅ is —(CH₂)ₙCO₂H or CO₂H, respectively, and

A is OH or N(Rₐ)(R_{b}), wherein Rₐ and R_{b} are independently selected from hydrogen and C₁-C₆ alkyl.

In one embodiment, the probe is a hybridization probe. In one embodiment, the probe is a hydrolysis probe.

In another embodiment, the invention provides a composition, comprising:

(a) a compound having the formula:

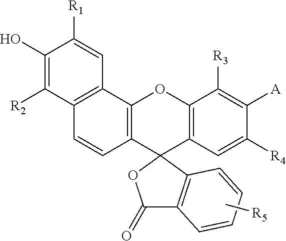

or its active esters, acid base forms, tautomers, or salts, wherein

R₁ is selected from halo, C₁-C₆ alkyl, C₁-C₆ haloalkyl, and C₁-C₆ alkoxy;

R₂ is selected from hydrogen, halo, C₁-C₆ alkyl, C₁-C₆ haloalkyl, and C₁-C₆ alkoxy;

R₃ is selected from hydrogen, halo, C₁-C₆ alkyl, C₁-C₆ haloalkyl, and C₁-C₆ alkoxy;

R₄ is selected from hydrogen, halo, C₁-C₆ alkyl, C₁-C₆ haloalkyl, and C₁-C₆ alkoxy, and —(CH₂)ₙCO₂H, where n is 1-3, and

R₅ is selected from hydrogen and CO₂H,

provided that at least one of R₄ and R₅ is —(CH₂)ₙCO₂H or CO₂H, respectively, and

A is OH or N(Rₐ)(R_{b}), wherein Rₐ and R_{b} are independently selected from hydrogen and C₁-C₆ alkyl; and

(b) one or more second fluorescent compounds.

In one embodiment, the second fluorescent compound is a seminaphthofluorescein or a seminaphthorhodamine.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 compares the emission spectra of a 2-chloro SNFL compound (EBIO-3) as a function of pH.

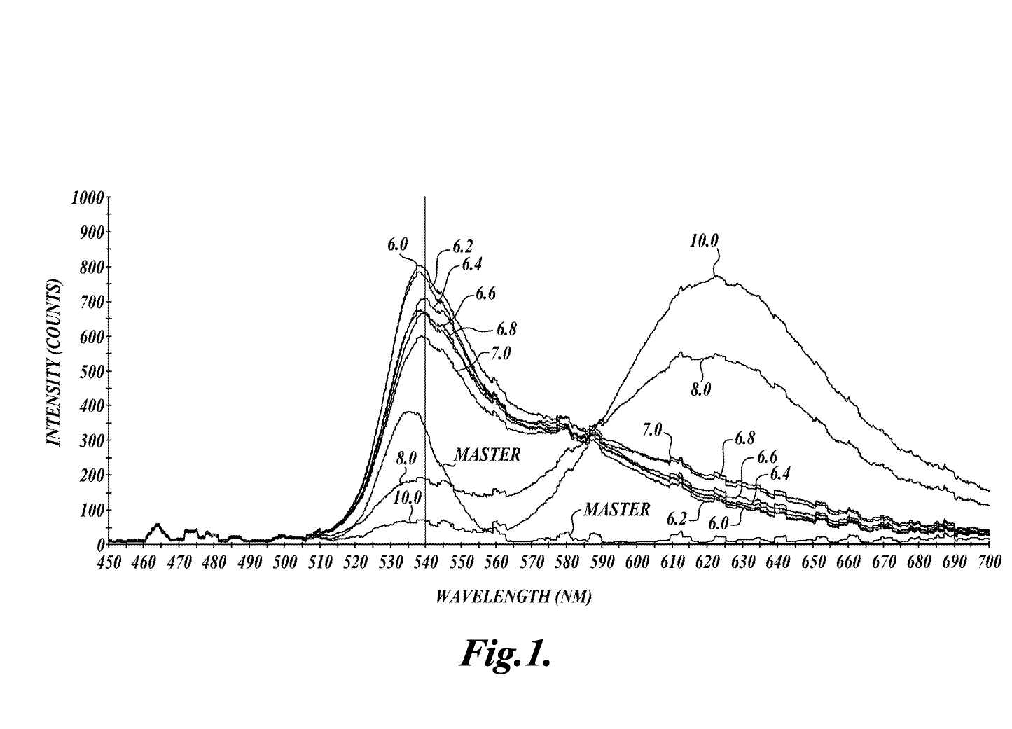

FIG. 2A compares the absorbance spectra of two representative compounds of the invention: a 2-chloro SNFL and a 2,4-dichloro SNFL.

FIG. 2B compares the emission spectra of two representative compounds of the invention: a 2-chloro SNFL and a 2,4-dichloro SNFL.

FIG. 3 is a schematic illustration of the preparation of a representative 2-chloro SNFL compound of the invention.

FIG. 4 is a schematic illustration of the preparation of a representative 2,4-dichloro SNFL compound of the invention.

FIG. 5 shows the UV-vis absorbance spectrum of a 1:1 (molar) mixture of representative 2-chloro and 2,4-dichloro SNFL compounds of the invention as a function of pH.

FIG. 6 is a schematic illustration of the preparation of a representative 2-chloro SNFL nucleic acid probe of the invention: reaction of 5′-hexylamine modified oligodeoxynucleotides with 2-chloro SNFL NHS ester.

FIG. 7 is a schematic illustration of the preparation of a representative 2-chloro SNFL phosphoramidite of the invention.

FIG. 8 compares the spectral overlap of fluorescein emission with Red 640 Roche LIGHTCYCLER probe absorbance.

### DETAILED DESCRIPTION OF THE INVENTION

The present invention provides low pKa fluorescent compounds (seminaphthofluorescein (SNFL) compounds and seminaphthorhodamine (SNRF) compounds), compositions that include the compounds, bioconjugates made from the compounds, methods for making the compounds, and methods for using the compounds.

The compounds of the invention include monohalo- and dihalo-compounds. In one embodiment, the 2-halo- and 2,4-dihalo compounds have formula (I):

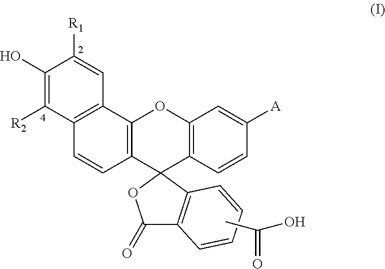

or its active esters, acid/base forms, tautomers, or salts, wherein R₁ is halo and R₂ is hydrogen or halo, and wherein A is OH or N(Rₐ)(R_{b}), wherein Rₐ and R_{b} are independently selected from hydrogen and C1-C6 alkyl. The compounds of formula (I) are depicted in their lactone form. It will be appreciated that the seminaphthol and seminaphtholate forms shown herein and their acid/base forms, tautomers (e.g., keto-acid form), ions, and salts are within the scope of the invention.

Representative SNFL compounds of the invention include monochloro- and dichloro-SNFL compounds, such as 2-chloro- and 2,4-dichloro SNFL compounds having the structures below.

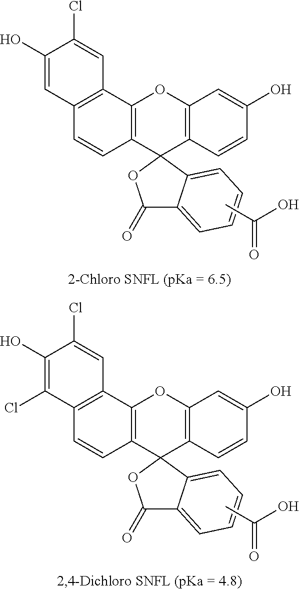

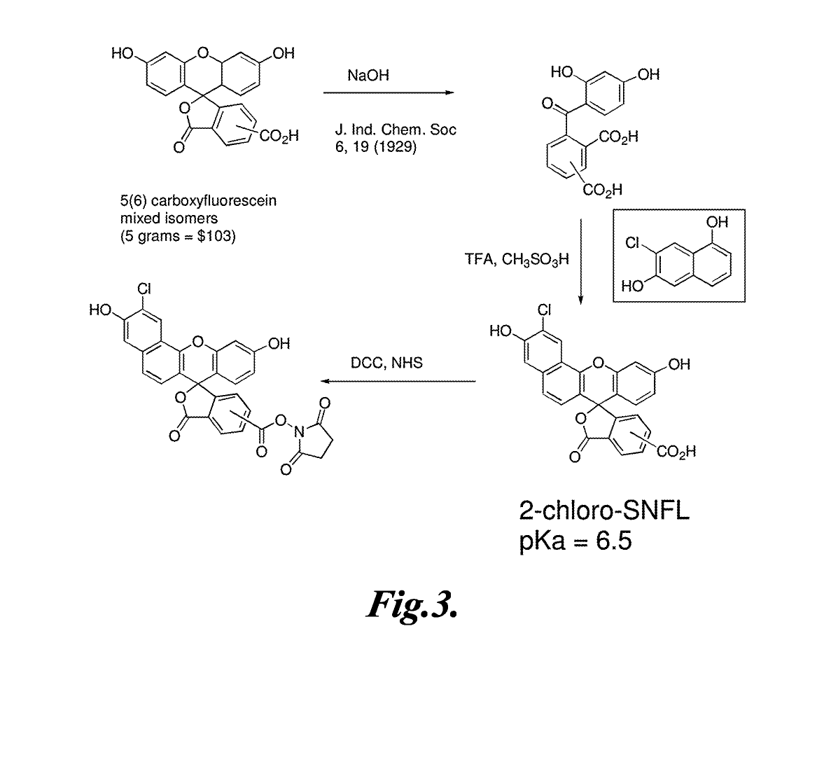

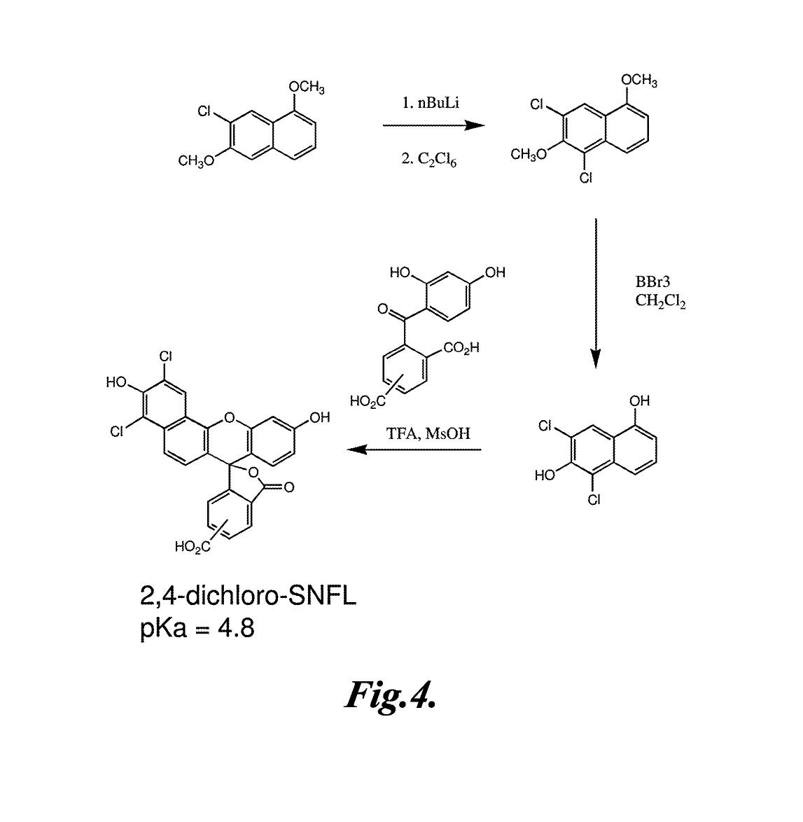

The preparation of a representative 2-chloro SNFL compound is described in Example 1 and shown in FIG. 3. The preparation of a representative 2,4-dichloro SNFL compound is described in Example 2 and shown in FIG. 4.

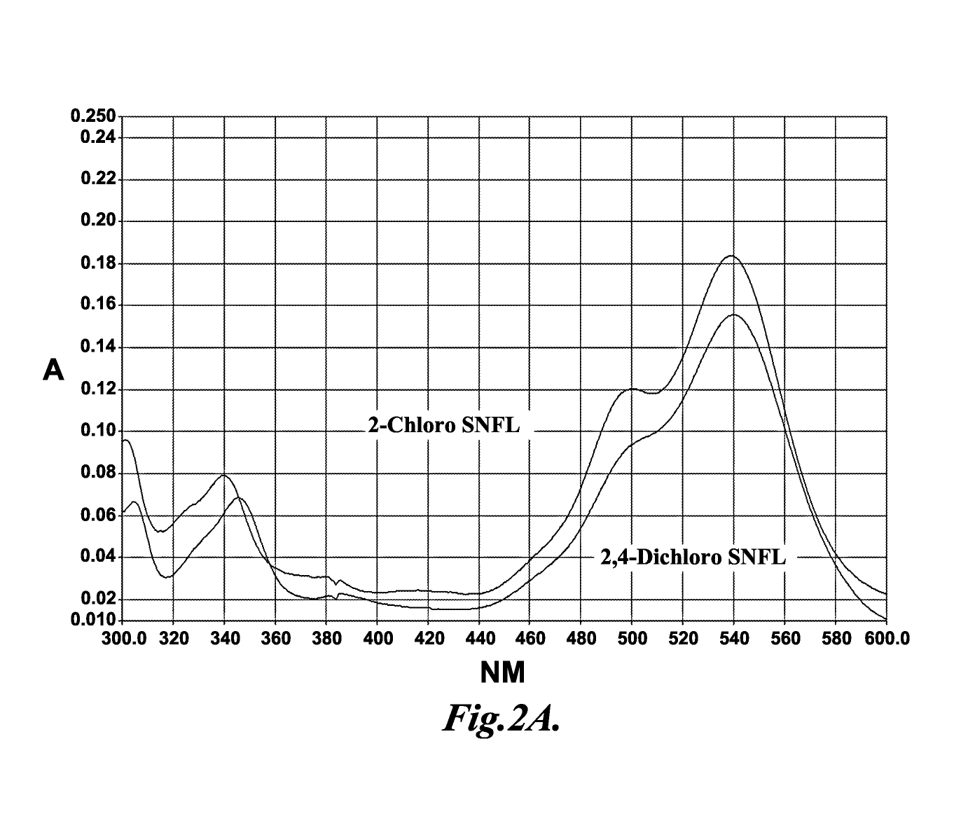

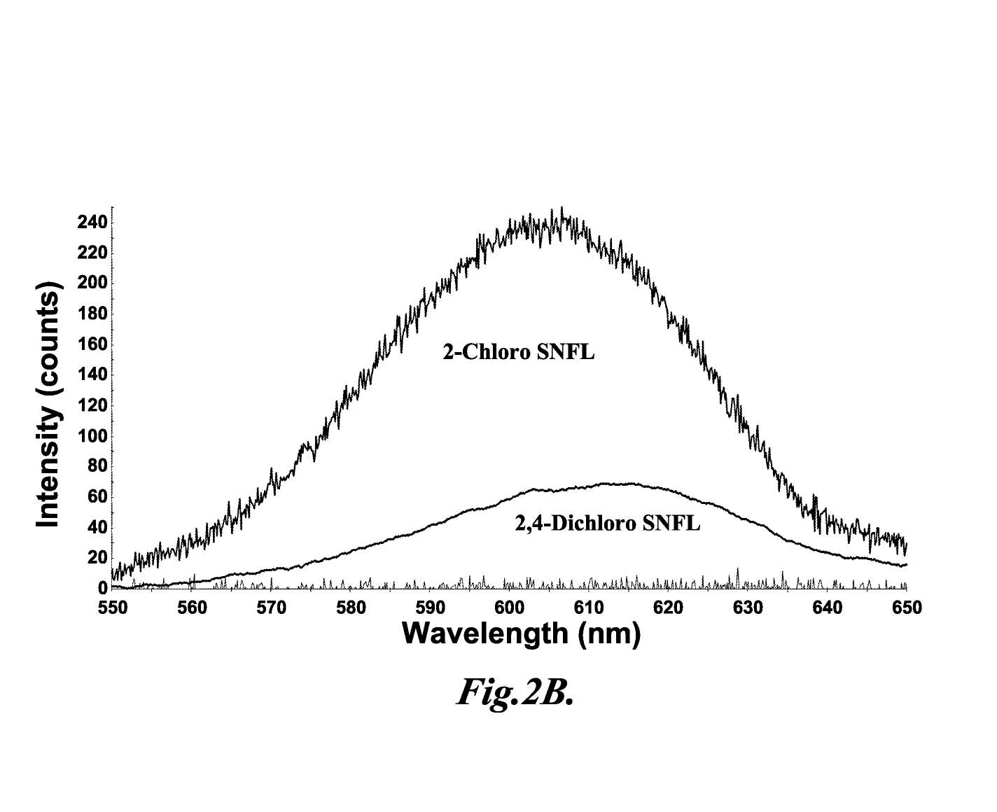

Despite the halo (e.g., chloro) substitution, the compounds of the invention exhibit absorbance and fluorescence emission spectra that are similar to unsubstituted seminaphthofluorescein. At pH 8.0, the emission wavelength maximum for the 2-chloro SNFL compound of the invention is about 605 nm and the emission wavelength maximum for the 2,4-dichloro SNFL compound of the invention is about 615 nm. The absorbance and emission spectra of the compounds of the invention are shown in FIGS. 2A and 2B, respectively.

The low pKa of the compounds of the invention provides advantageous fluorescent properties as described in a variety of applications.

pH Sensors

The compounds of the invention are low pH sensors that effectively extend the range of pH measurement from the previous range of 7-9 (SNFL) to 5.5-7.5 (2 chloro SNFL) and 4.8-5.8 (2,4-dichloro SNFL). The chloro compounds can be used in the preparation of pH sensors. A monochloro SNFL has been used in the preparation a pH sensing platelet storage bag that gave accurate measurement in human plasma at pH 6.5. See U.S. Pat. No. 7,608,460, expressly incorporated herein by reference in its entirety. The pH sensors were constructed from an immobilized monochloro SNFL human serum albumin conjugate. The compounds of the invention provide sensors having accuracy at lower pH ranges and the unsubstituted SNFL compound provides sensors having accuracy at higher pH ranges.

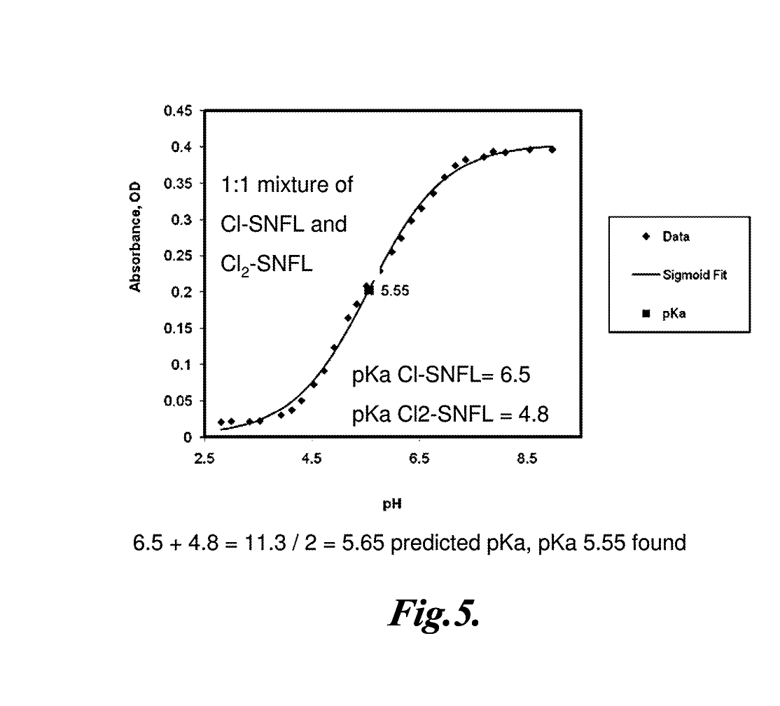

In one aspect of the invention, compositions comprising a blend of two or more fluorescent compounds are provided. The composition includes one or more of the compounds of the invention. In one embodiment, the composition includes a 1:1 mixture (molar) of the chloro SNFL compounds of the invention (i.e., 2-chloro SNFL and 2,4 dichloro SNFL). The pKa of 2-chloro SNFL is 6.5, the pKa of 2,4-dichloro SNFL is 4.8, the predicted pKa of a 1:1 (molar) mixture is 5.65 (6.5+4.8=11.3/2), and the observed pKa was 5.55. See FIG. 5. The compounds of the invention can be blended (optionally with SNAFL or other fluorescent compounds) to tune the pKa of the mixture for accuracy at specific pH levels. In one embodiment, the composition includes a mixture (molar) of SNFL and the chloro SNFL compounds of the invention (i.e., 2-chloro SNFL and 2,4-dichloro SNFL) to provide a single sensor with extended pH reading accuracy from pH 4.8 to 8.8. The non-fluorescent lactone form of the dye (pKa of acid about 4) limits the low end accuracy to about the pKa of 2,4-dichloro SNFL pH 4.8).

It has been found that the fluorescence of 2,4-dichloro SNFL diminishes as pH is lowered, resulting in the useful lower limit of 4.7, above the theoretical lower limit of approximately 3.5. While not wishing to be bound by theory, the observed loss of fluorescence may result from aggregation of the dye and may be overcome by conjugation to a solubilizing molecule such as albumin, immobilization to a solid support (see, e.g., U.S. Pat. No. 7,608,460), or addition of a suitable hydrophilic organic solvent such as a non-ionic surfactant, alcohol, polyethylene glycol, or the like.

Fluorescent Labels

In another aspect of the invention, fluorescently labeled compounds and conjugates are provided. The fluorescently labeled compounds and conjugates can be prepared from the compounds of the invention and macromolecules including proteins, polypeptides, peptides, and nucleic acids. Fluorescently labeled proteins (e.g., antibodies, antibody fragments, receptors, receptor fragments, enzyme substrates) and nucleic acids (e.g., fluorogenic nucleic acid probes derived from DNA, RNA) are conveniently prepared from the compounds of the invention, or their reactive derivatives, for use in molecular diagnostic assays.

The low pKa of the compounds provide a unique advantage for use in assays that function in the pH range 7 to 9. For example, at pH 7.8 the unsubstituted SNFL dye (parent SNFL) is a 50:50 mixture of an orange fluorescent (624 nm) and yellow fluorescent (539 nm) form of the dye. Therefore unsubstituted SNFL is not a convenient label for bioassays performed at pH 7-9 because the emitted radiation is divided into two wavelength bands. Furthermore, the pH sensitivity of SNFL complicates the assay because the fluorescence emission needs to be captured over a wider wavelength band and the required optical filters reduce sensitivity. Thus SNFL dyes have not been used in bioassays as simple labels.

However, the low pKa compounds of the invention solve this problem. For example, if 2-chloro SNFL (pKa 6.5) is used as a label for a bioassay that runs in a pH 7.5 buffer, a 90:10 mixture of the red and yellow forms of the compound exist. The situation is improved for 2,4-dichloro SNFL (pKa 4.8) when used as a label in pH 7.5 assays because the compound is over 99% ionized, virtually a single form. The naphtholate forms of chloro SNFL compounds can be excited with green light (540 nm) and emit at orange wavelengths (605-615 nm). This large Stokes shift simplifies optics and maximizes signal capture because reflected excitation light is easily filtered from the desired fluorescence.

Nucleic Acid Labeling Reagents

In another aspect of the invention, nucleic acid labeling reagents are provided. Labeled nucleic acid probes (e.g., hybridization probes and hydrolysis probes) can be prepared using the compounds of the invention in the form of activated esters, phosphoramidites, and solid supports.

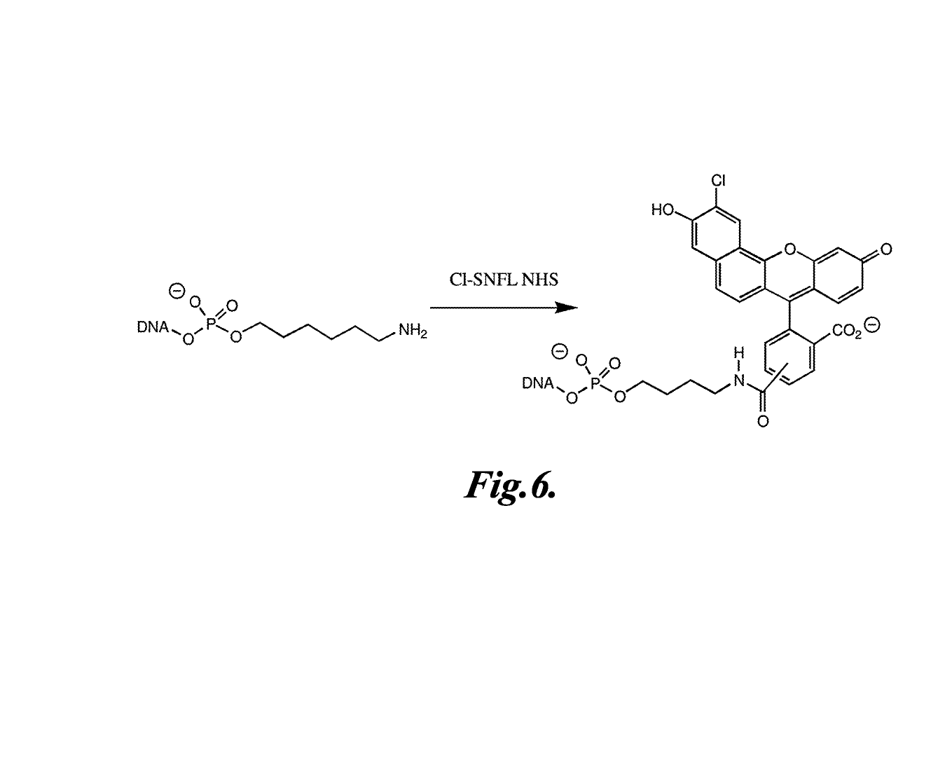

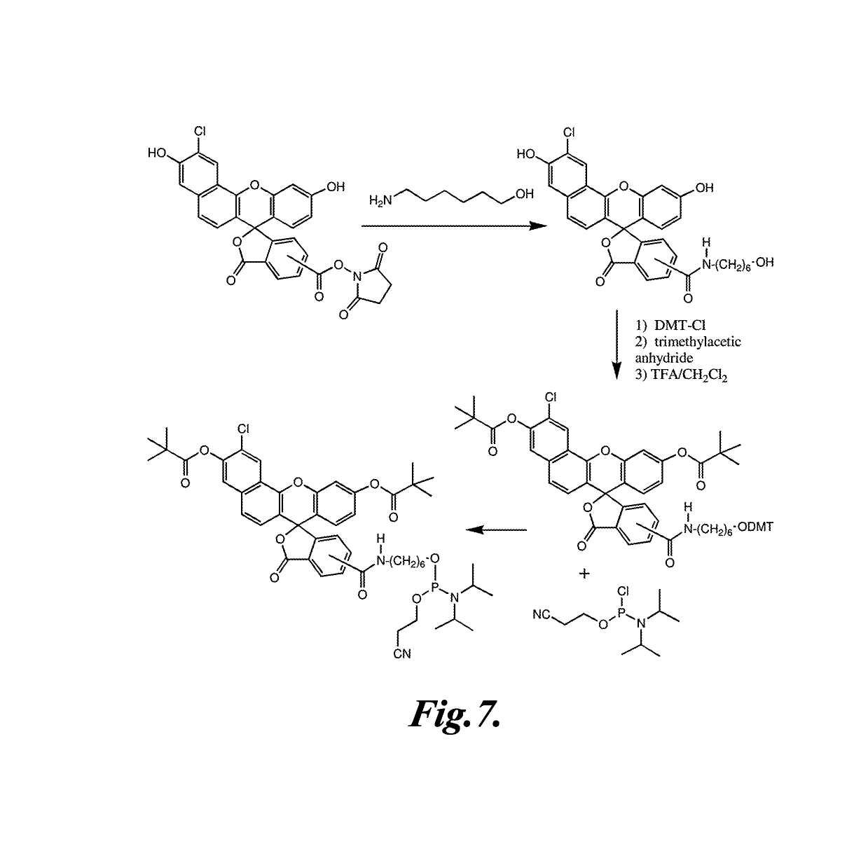

FIG. 6 is a schematic illustration of the preparation of a representative SNFL nucleic acid probe of the invention by reaction of a 5′-hexylamine-modified oligodeoxynucleotide with 2-chloro SNFL NHS ester. FIG. 7 is a schematic illustration of the preparation of a representative SNFL phosphoramidite of the invention. It will be appreciated that other SNFL compounds of the invention (e.g., 2,4-dichloro SNFL) can be used to label oligonucleotides as described above for the 2-chloro SNFL (e.g., active esters, phosphoramidites, solid supports).

When DNA detecting dyes or DNA detecting fluorogenic probes are added to PCR reactions, the fluorescent signal grows as the amplified DNA increases in concentration at each PCR cycle. When fluorescence is measured at each PCR cycle this process is known as real-time PCR (real-time PCR is often called quantitative PCR or qPCR) and it allows the amount of DNA target to be quantitated if a standard curve is run. Although simple intercalating fluorogenic dyes, such as SYBR Green can be used in qPCR, synthetic DNA probes are the best choice for rapid progress toward a functioning quantitative PCR assay. Unlike fluorogenic dyes, the sequence specificity of DNA probes allows detection of only the desired amplified sequence. The use of two different probes with two different color fluorescent labels allows built in controls that simplify the complexity of the test. The probes can be made using high throughput DNA synthesizers. DNA synthesis reagents are used to attach fluorescent quenching molecules to one end of the 20-30 mer strand (using modified solid supports) and fluorescent dyes to the opposite end of the strand (using phosphoramidite reagents). Alternatively, the fluorescent dye can be attached to a hexylamine modified oligo in a separate conjugation step.

There are two classes of fluorescent DNA probe assays: hydrolysis probes and hybridization probes. Each assay uses probes that fluoresce in the presence of complementary DNA or RNA strands (fluorogenic probes), although the mechanisms of fluorescent signal generation are different.

The vast majority of probes used are hydrolysis probes (TAQMAN probes, ABI and Roche). TAQMAN probes are digested by Taq polymerase during the PCR and give excellent fluorescent signals because the fluor and quencher are cleaved from each other. Hybridization probes are best represented by the Molecular Beacons (see U.S. Pat. Nos. 5,925,517; 6,103,476; and 7,385,043, each expressly incorporated herein by reference in its entirety). Beacons are dual-labeled probes with a hairpin structure that positions the fluor and quencher molecules next to each other. Beacons have low fluorescence unless the complementary target strand is present as a result of amplification. It is better to use one primer in excess so that there is excess target strand at the end of the PCR (asymmetric PCR). Hybridization probes can also be designed in a two probe format where a “donor probe” (anchor probe) is labeled with a green emitting dye (fluorescein, Ex 490, Em 520) and the “acceptor probe” (emitter probe) has a red emitting fluor (Red 640, Em 640 nm) that is excited by the green emitting fluor by a process known as fluorescence resonance energy transfer (FRET) if both probes hybridize to the desired target DNA strand and the fluors are positioned next to each other. Red fluorescence occurs with 490 nm Ex only if both probes are hybridized.

Multiplexed Probes.

The large Stokes shift of the compounds of the invention simplifies multiplexing where there is more than one indicating dye in a single reaction. For example, chloro SNFL-labeled oligonucleotide probes (Em=605) can be combined with hexachlorofluorescein (HEX)-labeled probes (Em=556) using a single excitation wavelength (540 nm). An advantage of the hybridization probes is that they can be present during quantitative PCR and are resistant to digestion. That allows (low resolution) melting curve analysis after PCR to distinguish single point mutations. There are a plethora of fluorogenic assay formats and all could take advantage of the large Stokes shift of the chloro SNFL compounds of the invention simplifying detection in multiplexed assays. Commercial fluorogenic probe assays include two-probe fluorescence resonance energy transfer (FRET) assay (used in Roche LIGHTCYCLER system), Molecular Beacons (PHRI hybridization probes), minor groove binding (MGB) probes (Epoch/Nanogen/Elitech hybridization probes), TAQMAN probes (Roche/ABI hydrolysis probes), and INVADER assay (Hologic hydrolysis probes). The SNFL compounds of the invention can be incorporated into the above two-probe fluorescence resonance energy transfer systems and assays.

Two-Color Molecular Beacons.

The compounds of the invention can be used to develop the hairpin-shaped Molecular Beacon probes for use with isothermal amplification assays (e.g., NASBA). In this embodiment, the quencher molecule DABCYL has been shown to quench fluorescent moieties having long wavelength emission spectra similar to the 2-chloro SNFL or 2,4-dichloro SNFL moieties of this invention. In this application, a yellow emitting fluor is easily multiplexed with the orange emitting chloro SNFL fluors of this invention.

Two-Color FRET Probes.

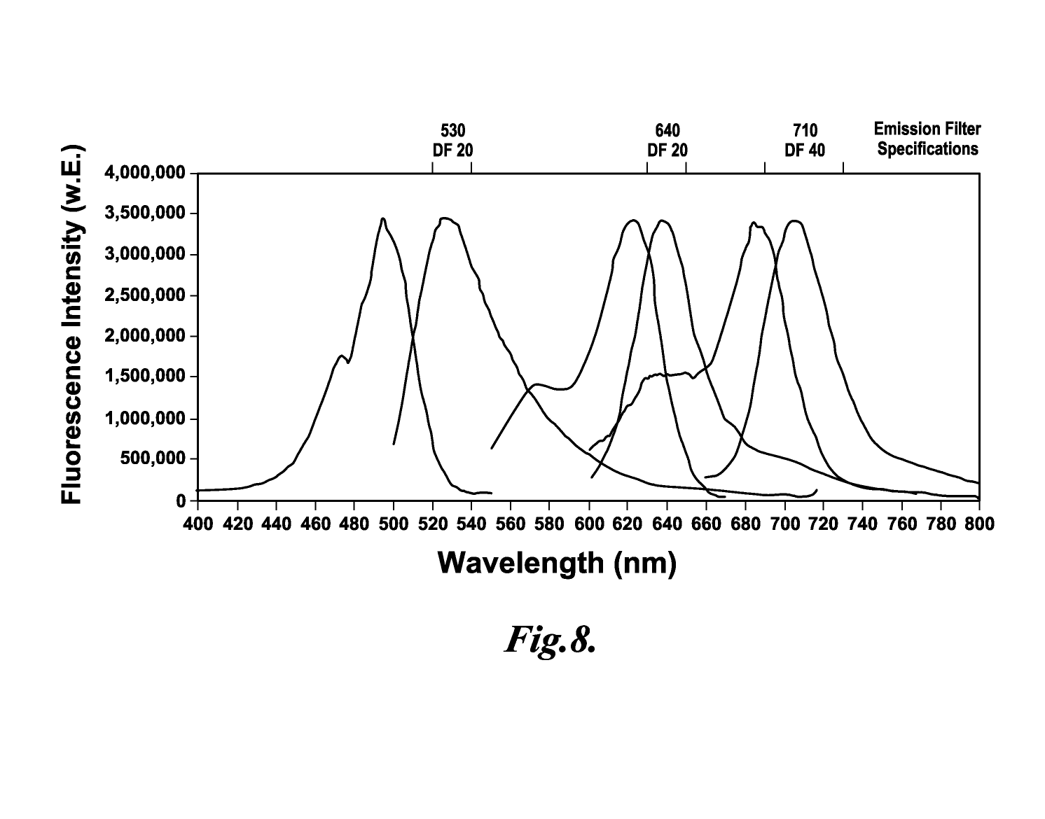

The SNFL probes of this invention work especially well in the “anchor probe”/“emitter probe” hybridization format. The current Red 640 label in the Roche LIGHTCYCLER probes has poor spectral overlap with the fluorescein emission (FIG. 8) whereas the chloro SNFL has much better overlap due to the large Stokes shift. Another yellow- or orange-labeled emitter probe (HEX or TAMRA) can be duplexed with the chloro SNFL probes. Sensitivity of the assay generally improves as spectral overlap increases.

Two-Color Hydrolysis Probes.

Hydrolysis probes like TAQMAN with yellow emitting labels are suitable for qPCR assays and are commercially available. These probes use special quencher molecules with long wavelength absorbance that overlaps with the emitted fluorescence of the label. For example, BLACK HOLE quencher (Biosearch) is available with three different structures that are designed to overlap (quench) fluors having emissions from green to red. BHQ2 is an effective quencher for yellow dyes and has been used successfully for HEX-labeled hydrolysis probes. HEX is hexachlorofluorescein (Ex 535/Em 556 nm). Dichlorodiphenylfluorescein, SIMA (HEX) exhibits virtually identical absorbance and emission spectra to HEX (Ex 538/Em 551 nm). SIMA (HEX) is much more stable to basic deprotection conditions than HEX and oligonucleotides can be deprotected using ammonium hydroxide at elevated temperatures and even ammonium hydroxide/methylamine (AMA) at room temperature or 65° C. for 10 minutes. YAKIMA YELLOW phosphoramidite (Ex 530/Em 549 nm) (U.S. Pat. No. 6,972,339) and synthetic probes using this dye are available from Eurogentec. Probes containing HEX and BLACK HOLE Quenchers are commercially available (e.g., Integrated DNA Technologies (IDT), Coralville Iowa, and Biosearch, Novato, Calif.).

Thus, in other aspects of the invention, fluorogenic probes prepared from the compounds of the invention are provided. The fluorogenic probes of the invention can be used in the methods described above and known in the art.

In one embodiment, the invention provides a fluorogenic probe prepared from a compound of the invention and an oligonucleotide.

In one embodiment, representative fluorogenic probes of the invention have the formula: F₁-OGN₁, where F₁ is a compound of the invention, ° GN₁ is an oligonucleotide suitable for use as hybridization probe. These probes can be used as emitter probes in combination with anchor probes having the formula: F₂-OGN₂, where F₂ is a fluorescent compound having an emission spectrum that overlaps the absorption spectrum of F₁, and OGN₂ is an oligonucleotide suitable for use as hybridization probe, such that on hybridization fluorescence resonance energy transfer occurs from F₂ to F₁ (e.g., OGN₂—F₂:F₁-OGN₁). Representative fluorogenic probes of the invention having the formula F₁-OGN₁ can also be used as anchor probes in combination with emitter probes having the formula: F₃-OGN₃, where F₃ is a fluorescent compound having an absorption spectrum that overlaps the emission spectrum of F₁, and OGN₃ is an oligonucleotide suitable for use as hybridization probe, such that fluorescence resonance energy transfer occurs from F₁ to F₃ on hybridization (e.g., OGN₁-F₁:F₃-OGN₃).

In another embodiment, representative fluorogenic probes of the invention have the formula: F₁-OGN-F₂, where F₁ is a compound of the invention, OGN is an oligonucleotide suitable for use as hybridization probe, and F₂ is a fluorescent compound having an emission spectrum that overlaps the absorption spectrum of F₁, such that fluorescence resonance energy transfer occurs from F₂ to F₁ in solution, and fluorescence resonance energy transfer is lost on hybridization. In another embodiment, representative fluorogenic probes of the invention have the formula: F₁-OGN-F₃, where F₁ is a compound of the invention, OGN is an oligonucleotide suitable for use as hybridization probe, and F₃ is a fluorescent compound having an absorption spectrum that overlaps the emission spectrum of F₁, such that fluorescence resonance energy transfer occurs from F₁ to F₃ in solution, and fluorescence resonance energy transfer is lost on hybridization.

In a further embodiment, the invention provides fluorogenic probes prepared from a compound of the invention, a suitable quencher, and an oligonucleotide. Representative fluorogenic probes of the invention have the formula: F₁-OGN-Q, where F₁ is a compound of the invention, OGN is an oligonucleotide suitable for use as a Molecular Beacon or TAQMAN probe, and Q is a quencher effective to quench F₁ fluorescence in solution, but not on hybridization.

In other aspects, methods for using the fluorogenic probes of the invention are provided. The methods that include the use of the fluorogenic probes of the invention include those described above and known in the art.

In other aspects, kits including the fluorogenic probes of the invention are provided.

DNA Synthesis Reagents

Active esters (e.g., NHS) of the compounds of the invention can be used to prepare oligonucleotide conjugates. Current conjugation reactions are labor intensive and require careful handling. Labels can be introduced during automated DNA synthesis by converting them to phosphoramidite reagents or synthesizing modified solid supports for DNA synthesis. Glen Research (Sterling, Va.) sells CPG solid supports and phosphoramidite reagents to introduce fluorescent labels (Gig Harbor Green, Yakima Yellow, Redmond Red) and ECLIPSE Quencher. The reagents allow versatile synthesis of FRET probes for use as hydrolysis or hybridization probes. The methods are published and the reagents are patented. In particular, YAKIMA YELLOW has ideal properties as a matched set for the large Stoke's shift compounds of the invention.

The compounds of the invention can be used in dual-probe kits and methods as either the emitter or the acceptor, depending on the second probe. For example, in one embodiment, YAKIMA YELLOW can be paired with a compound of the invention (e.g., 2-chloro SNFL and 2,4-dichloro SNFL) for use FRET kits and methods in which YAKIMA YELLOW is the anchor and the SNFL compound is the emitter; and in another embodiment, a compound of the invention (e.g., 2-chloro SNFL and 2,4-dichloro SNFL) can be paired with RED 640 in FRET kits and methods in which the SNFL compound is the anchor and RED 640 is the emitter. It will be appreciated that other combinations including the compounds of the invention are with the scope of the invention.

In addition to the compounds described above, the compositions, methods, and kits of the invention use and include fluorogenic probes made from compounds having formula (II):

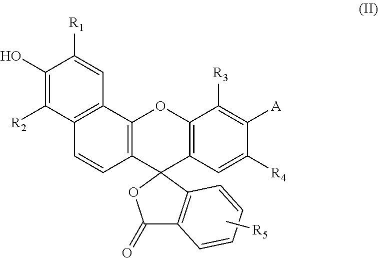

or its active esters, acid/base forms, tautomers, or salts, wherein

R₁ is selected from halo, C₁-C₆ alkyl, C₁-C₆ haloalkyl, and C₁-C₆ alkoxy;

R₂ is selected from hydrogen, halo, C₁-C₆ alkyl, C₁-C₆ haloalkyl, and C₁-C₆ alkoxy;

R₃ is selected from hydrogen, halo, C₁-C₆ alkyl, C₁-C₆ haloalkyl, and C₁-C₆ alkoxy;

R₄ is selected from hydrogen, halo, C₁-C₆ alkyl, C₁-C₆ haloalkyl, and C₁-C₆ alkoxy, and —(CH₂)ₐCO₂H, where n is 1-3, and

R₅ is selected from hydrogen and CO₂H,

provided that at least one of R₄ and R₅ is —(CH₂)ₙCO₂H or CO₂H, respectively, and

A is OH or N(Rₐ)(R_{b}), wherein Rₐ and R_{b} are independently selected from hydrogen and C1-C6 alkyl.

In certain embodiments of the compounds of formula (II) where A is N(Rₐ)(R_{b}), substituents A and R₃ are taken together with the atoms to which they are attached form a six-membered N-containing ring (e.g., R₃ and Rₐ or R_{b} are taken together to form a ring).

The compounds of formula (II) are depicted in their lactone form. It will be appreciated that the seminaphthol and seminaphtholate forms shown herein and their tautomers (e.g., keto-acid form), ions, and salts are within the scope of the invention.

As used herein, the term “halo” refers to chloro, bromo, and fluoro.

The term “C₁-C₆ alkyl” refers to straight chain and branched alkyl groups having from 1 to 6 carbons (e.g., methyl, ethyl, n-propyl, i-propyl).

The term “C₁-C₆ haloalkyl” refers to halo-substituted straight chain and branched alkyl groups having from 1 to 6 carbons (e.g., fluoromethyl, trifluoromethyl, 1,1,1-trifluoroethyl).

The term “C₁-C₆ alkoxy” refers to alkoxy groups including straight chain and branched alkyl groups having from 1 to 6 carbons (e.g., methoxy, ethoxy, n-propyl, i-propyl).

In one embodiment, R₁ is C₁, R₂ is H, R₃ is H, R₄ is H, R₅ is CO₂H, and A is OH [2-chloro SNFL].

In one embodiment, R₁ is C₁, R₂ is C₁, R₃ is H, R₄ is H, R₅ is CO₂H, and A is OH [2,4-dichloro SNFL].

In one embodiment, R₁ is C₁, R₂ is H, R₃ is H, R₄ is —(CH₂)ₙCO₂H, R₅ is H, and A is OH. In one embodiment, n is 2 [EBIO-3].

In one embodiment, R₁ is C₁, R₂ is H, R₃ is C₁, R₄ is —(CH₂)ₙCO₂H, R₅ is H, and A is OH. In one embodiment, n is 2 [EBIO-1].

The preparations of certain compounds of formula (II) having R₄ is —(CH₂)ₙCO₂H, n=2, are described in U.S. Pat. Nos. 6,972,339; 7,112,684; 7,601,851; and U.S. Patent Application Publication No. US 2006/0204990, each expressly incorporated herein by reference in its entirety. The preparation of certain other compounds of formula (II) are described in U.S. Pat. No. 4,945,171, expressly incorporated herein by reference in its entirety.

In one embodiment, the compositions, methods, and kits of the invention use and include fluorogenic probes made from compounds having formula (III):

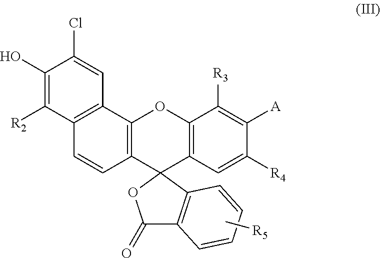

or its active esters, wherein R₂ is H or Cl, R₃ is H or Cl, R₄ is H or —(CH₂)ₙCO₂H, where n is 1-3, and R₅ is H or CO₂H, provided that R₄ and R₅ are not both H, and wherein A is OH or N(Rₐ)(R_{b}), wherein Rₐ and R_{b} are independently selected from hydrogen and C1-C6 alkyl. In one embodiment, A is OH and n is 2.

The compounds of formulas (II) and (III) can be used as described above (e.g., pH sensors, active esters, fluorescent labels, nucleic acid labeling reagents, DNA synthesis reagents) to provide fluorescently labeled materials, such as fluorescently labeled proteins, peptides, and oligonucleotides (e.g., fluorogenic probes).

Instrumentation for Measuring Emission

The large Stokes shift of the compounds of the invention simplifies multiplexing where there is more than one indicating dye in a single reaction. For example, chloro SNFL-labeled oligonucleotide probes (Em=605) can be combined with hexachlorofluorescein (HEX) labeled probes (Em=556) using a single excitation wavelength (540 nm). A fluorescence detector with optical filters tuned for the chloro SNFL spectral properties is available (pH1000, Blood Cell Storage Inc., Seattle Wash., see U.S. Pat. No. 7,680,460 describing LED excitation/photodiode detection). The large Stoke's shift of the chloro SNFL compounds of the invention enables use of this single excitation, two channel detector system. These optical reading devices can be coupled with precise thermal control for DNA amplification and melting curve analysis of the amplified sequences can be used to identify specific DNA sequences by monitoring changes in fluorescence versus temperature. Endpoint assays will eliminate the need for careful temperature control.

Each reference cited herein is incorporated by reference in its entirety.

The following examples are provided for the purpose of illustrating, not limiting, the invention.

### EXAMPLES

### Example 1

### The Preparation of a Representative 2-Chloro Seminaphthofluorescein Compound, Active Ester, and Protein Conjugate

In this example, the preparation of a representative 2-chloroseminaphthofluorescein, its N-hydroxysuccinimide ester, and human serum albumin conjugate are described. The preparation of 2-chloro SNFL is illustrated in FIG. 3.

Hydrolysis of Carboxyfluorescein.

5,(6)-Carboxyfluorescein (15.0 g, 39.9 mmol) was added to a mixture of sodium hydroxide (30.1 g) in 15.0 mL of water, and stirred at 160° C. The reaction was then stirred for 60 min, during which time the reaction color turned from deep purple to light brown. A sample of the solution in water was no longer fluorescent when spotted on a TLC plate. The solution was cooled to room temp overnight, diluted with 250 mL of water and precipitated by addition of conc. HCl. About 60 mL of HCl was added until about pH 3. The solution was cooled to 5° C. and the crystals that formed were filtered and dried (yield=4.88 g). The filtrate was poured into an evaporation dish and placed in the hood for a few days. The solid that formed was filtered and rinsed with water (yield=9.29 g). The combined product (118% yield) was dissolved in 100 mL of boiling ethanol (absolute) and the insoluble salt material was filtered off and 200 mL water was added to the filtrate. After standing in the hood overnight the solid that formed was filtered and rinsed with water and dried to give 10.95 g (36.3 mmol, 91% yield) of the dicarboxylic acid (MW 302).

### 7-Chloro-1,6-dimethoxynaphthalene

1,6-Dimethoxynaphthalene (19.57 g, 104 mmol, MW 188.2) was dissolved in 65 mL of dry THF and cooled in an acetone/dry ice bath with stirring. N-Butyl lithium (11.35 mL of a 10 M butyl lithium solution in hexanes) was added gradually over a 30 min period. The mixture was allowed to warm to room temp and then stirred for 1 hour. The mixture was then cooled again in the acetone/dry ice bath and hexachloroethane (27 grams in 60 mL of dry THF) was added dropwise over a 30 min period. The mixture was allowed to warm to room temp and stirred for 30 min. TLC analysis shows no starting material (R_{f} 0.57) remaining (TLC: 20% ethyl acetate in hexane) and a single major product (R_{f} 0.51). The solvents were evaporated and the residue was loaded onto a silica gel column (22×5 cm) using a min volume of ethyl acetate. The UV active material was then eluted off the column with 1:1 hexane:ethyl acetate as one fraction. The solvents were evaporated and the residue was dissolved in 150 mL of dry ether and placed in a −20° C. freezer overnight. The crystals that formed were collected to yield 8.58 g. A test sample was analyzed by deprotecting with boron tribromide as described below and analyzing the results by TLC which showed a slight amount of dichloro product was present. The product was therefore recrystallized from 45 mL ether producing pure monochloro product. Yield was 6.33 g (30.4 mmole, MW=208), 29% yield.

### 7-Chloro-1,6-dihydroxynaphthalene

7-Chloro-1,6-dimethoxynaphthalene (6.33 g, 28.5 mmol, MW=222), was dissolved in 60 mL of dry methylene chloride. Boron tribromide (115 mL of a 1 M solution in methylene chloride) was added. The solution was allowed to sit overnight at room temp under argon. The solution was carefully poured over about 500 mL of ice water. The ice was allowed to melt, and the mixture was diluted with 500 mL of methylene chloride. The mixture was filtered and the solid filter cake (containing some product) was rinsed with another 500 mL of methylene chloride. The organic phase was isolated and dried over magnesium sulfate, filtered and evaporated to afford a solid with yield of 4.89 g (MW=194.6, 25.1 mmole, 88% yield).

2-Chloro SNFL.

7-Chloro-1,6-dihydroxynaphthalene (4.89 g, 25.1 mmol, MW=194.6) and the hydrolyzed fluorescein prepared as described above (6.35 g, 21.0 mmol) were stirred in trifluoroacetic acid (23 mL) and methanesulfonic acid (8.0 mL) at 80° C. (oil bath) for 2 hours. The oil bath was removed and the mixture allowed to stand overnight at room temperature. The solution was poured into 400 mL water with rapid stirring. The solid that formed was filtered and dried under vacuum to give crude yield of 12.1 g. This product was suspended in 250 mL of water and 2 N sodium hydroxide was added dropwise with stirring until the material dissolved. This aqueous solution was extracted with 3×300 mL of methylene chloride. TLC (10% methanol in methylene chloride) showed uptake of excess dihydroxynaphthalene. The aqueous phase was then re-acidified to about pH 3 by adding conc. HCl. The solid was filtered and dried under vacuum to give 9.8 g (21.3 mmol, 85% yield, MW=460.82). Reverse phase HPLC with UV-vis detection showed a mixture of the 5 and 6-carboxy isomers as a roughly equimolar mix. Gradient: TEAA buffer (pH 7.0)—acetonitrile, 0 to 40% in 15 min, then 40 to 100% in 18 (total) min, then hold at 100% until 25 min. TLC showed 1 major orange spot: R_{f} 0.53 (7:2:1, 2-propanol, water, ammonium hydroxide).

N-Hydroxysuccinimidyl ester of 2-chloro SNFL.

2-Chloro SNFL (50.0 mg, 0.109 mmoles) was dissolved in 0.3 mL of dry DMF and stirred at room temp. N-Hydroxysuccinimide (12.5 mg, 0.109 mmol) was dissolved in 0.15 mL of dry DMF and added to the stirring mix. After 10 min, a solution of dicyclohexylcarbodiimide (DCC) (12.5 mg, 0.109 mmol in 0.15 mL dry DMF) was added. A white solid (DCU) started precipitating after 10 min. After 2 hours at room temp, TLC (9:1/methylene chloride:methanol) showed complete reaction of the NHS and trace amounts of 2-chloro SNFL. The mix was placed at −20° C. for 1 hour, then transferred to an Eppendorf tube and centrifuged for 10 min. The supernatant was transferred to another flask and the pellet was washed with 0.5 mL dry DMF. The supernatant was combined and dried in vacuo to give 84.9 mg (141% yield) of crude product as a bright red residue. The product was purified on a silica column using methylene chloride/methanol. The desired product was isolated as an orange band and concentrated in vacuo to give 46.5 mg of the desired product (77% yield) as a red solid.

HSA conjugates of 2-chloro SNFL.

A solution of recombinant human serum albumin (HSA) obtained from Delta biotech as a 200 mg/mL solution. 1.25 mL (350 mg, 5.30 micromole) was added with stirring to 31.5 mL of sodium carbonate (pH 8.5) in a 50 mL polypropylene centrifuge tube. 2-Chloro-SNFL NHS ester (14.8 mg, 26.5 micromole) was dissolved in 1.75 mL of dry DMF and added dropwise with stirring to the HSA solution over 3 minutes. Stirring was continued for 5 min and the homogeneous solution was capped and allowed to react overnight protected from light. HPLC analysis with gel filtration packing and UV-vis detection showed a mixture of hydrolyzed NHS ester and 2-chloro-SNFL labeled HSA conjugate indicating extent of labeling was 3.5 fluors per HSA.

### Example 2

### The Preparation of a Representative 2,4-Dichloro Seminaphthofluorescein Compound, Active Ester, and Protein Conjugate

In this example, the preparation of a representative 2,4-dichloroseminaphthofluorescein, its N-hydroxysuccinimide ester, and human serum albumin conjugate are described. The preparation of 2,4-dichloro SNFL is illustrated in FIG. 3.

### 5,7-Dichloro-1,6-dihydroxynapthalene

7-Chloro-1,6-dimethoxynaphthalene (0.80 g, 3.6 mmol) was dissolved in 5.0 mL of dry THF. The solution was cooled in a dry ice/acetone bath with stirring. 2.25 mL of 1.6 M n-butyllithium (in hexane) was added and the reaction was warmed to room temp and stirred for 20 min. The reaction was cooled again in dry ice acetone bath and hexachloroethane (dissolved in 3 mL dry THF) was added and the mixture was allowed to stir overnight at room temp. The THF was evaporated off and the residue was dissolved in a min amount of 1:1/methylene chloride:hexane and applied to a silica gel column. The column was eluted with 5% ethyl acetate in hexane to give crude material. The crude dimethoxy material (about 130 mg) was dissolved in 2.0 mL of 1M boron tribromide in methylene chloride and allowed to react overnight. The reaction was poured over a small amount of ice water. Methylene chloride (50 mL) was added and the organic phase was separated, dried over magnesium sulfate and evaporated. The residue was suspended in water and 1 M sodium hydroxide was added to raise the pH to greater than 12. The mixture was filtered and the filtrate was stirred in a round bottom flask. 1 M HCl was added dropwise until a solid precipitate formed. The solid was filtered and shown to be a mixture of products by TLC. However the filtrate contained mostly pure product. The filtrate was stirred in a round bottom flask and acetic acid was added until the pH greater than 4. A white solid crystallized and was collected to give 48 mg (6% yield) of the pure product (TLC: R_{f} 0.5, 5% methanol in methylene chloride).

2,4-Dichloro SNFL.

Dichloro-dihydroxynaphthalene (29 mg, 0.127 mmol) was combined with 32 mg (0.106 mmol) of the hydrolyzed fluorescein compound, prepared as described in Example 1, in 0.28 mL of trifluoroacetic acid and 0.1 mL of methane sulfonic acid. After heating for 2 hours at 70° C., and overnight at room temperature about 5 mL of water was added. The solid that formed was collected and redissolved in water (pH about 6.5). The aqueous mixture was extracted with ethyl acetate three times to remove excess dichloro-dihydroxynaphthalene. The aqueous solution was then re-acidified by addition of 1 M HCl. The red precipitate that formed was filtered, rinsed with water and dried in vacuo to yield 26 mg (41%). Reverse phase HPLC showed a mixture of the 5 and 6-carboxy isomers as a roughly equimolar mix. Gradient: TEAA buffer (pH 7.0)—acetonitrile, 0 to 40% in 15 min, then 40 to 100% in 18 (total) min, then hold at 100% until 25 min. TLC showed 2 close running purple spots: R_{f} 0.56, 0.53 (7:2:1, 2-propanol, water, ammonium hydroxide).

### Example 3

### pKa Determination for 2-Chloro SNFL and 2,4-Dichloro SNFL

Dye solutions (2-chloro SNFL, 2,4-dichloro SNFL, and EBIO-3) were prepared as about 1 mM stock solutions in DMF and diluted with the appropriate buffer to a final concentration of 10 micromolar. Absorbance was measured at 570 nm and temperature was controlled at 22° C.: Polystyrene cuvettes (1 mL) were used. Absorbance was measured using about 30 different pH buffers in the range of 2.81 to 9.13. The pKa of the naphthol proton was determined as the inflection point in a plot of absorbance at 570 nm vs. pH. pKa was 6.6 for EBIO-3, 6.5 for 2-chloro-SNFL and 4.8 for 2,4-dichloro-SNFL.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A compound having the formula: 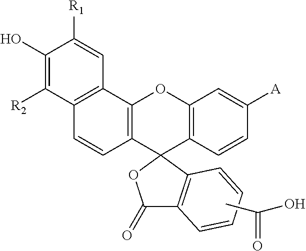
or its active esters, acid/base forms, tautomers, or salts, wherein
R₁ is halo,
R₂ is hydrogen or halo, and
A is OH or N(Rₐ)(R_{b}), wherein Rₐ and R_{b} are independently selected from hydrogen and C1-C6 alkyl.

2. The compound of claim 1, wherein R₁ is chloro and R₂ is hydrogen.

3. The compound of claim 1, wherein R₁ is chloro and R₂ is chloro.

4. The compound of claim 1, wherein A is OH.

5. The compound of claim 1, wherein A is N(CH₃)₂.

6. A nucleic acid probe prepared from a suitably reactive oligonucleotide and a compound of claim 1 or its active ester.

7. The probe of claim 6 further comprising a second fluorescent compound.

8. The probe of claim 7, wherein the second fluorescent compound has an emission spectrum that overlaps with the absorption spectrum of the compound of claim 1.

9. The probe of claim 7, wherein the second fluorescent compound has an absorption spectrum that overlaps with the emission spectrum of the compound of claim 1.

10. The probe of claim 7 further comprising a quencher moiety.

11. A method for determining the presence and/or amount of a nucleic acid in a sample, comprising contacting a sample optionally containing a target nucleic acid with a probe prepared from a suitably reactive oligonucleotide capable of hybridizing to the target nucleic acid and a compound having the formula: 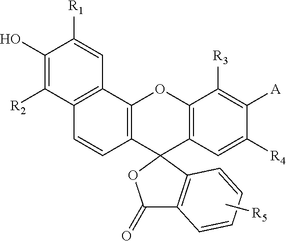
or its active esters, acid/base forms, tautomers, or salts, wherein
R₁ is selected from the group consisting of halo, C₁-C₆ alkyl, C₁-C₆ haloalkyl, and C₁-C₆ alkoxy;
R₂ is selected from the group consisting of hydrogen, halo, C₁-C₆ alkyl, C₁-C₆ haloalkyl, and C₁-C₆ alkoxy;
R₃ is selected from the group consisting of hydrogen, halo, C₁-C₆ alkyl, C₁-C₆ haloalkyl, and C₁-C₆ alkoxy;
R₄ is selected from the group consisting of hydrogen, halo, C₁-C₆ alkyl, C₁-C₆ haloalkyl, and C₁-C₆ alkoxy, and —(CH₂)ₙCO₂H, where n is 1-3,
R₅ is selected from the group consisting of hydrogen and CO₂H,
provided that at least one of R₄ and R₅ is —(CH₂)ₙCO₂H or CO₂H, respectively, and
A is OH or N(Rₐ)(R_{b}), wherein Rₐ and R_{b} are independently selected from hydrogen and C₁-C₆ alkyl.

12. The method of claim 11, wherein the probe is a hybridization probe.

13. The method of claim 11, wherein the probe is a hydrolysis probe.

14. A kit, comprising one or more nucleic acid probes prepared from a suitably reactive oligonucleotide and a compound having the formula: 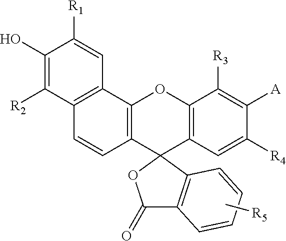
or its active esters, acid/base forms, tautomers, or salts, wherein
R₁ is selected from the group consisting of halo, C₁-C₆ alkyl, C₁-C₆ haloalkyl, and C₁-C₆ alkoxy;
R₂ is selected from the group consisting of hydrogen, halo, C₁-C₆ alkyl, C₁-C₆ haloalkyl, and C₁-C₆ alkoxy;
R₃ is selected from the group consisting of hydrogen, halo, C₁-C₆ alkyl, C₁-C₆ haloalkyl, and C₁-C₆ alkoxy;
R₄ is selected from the group consisting of hydrogen, halo, C₁-C₆ alkyl, C₁-C₆ haloalkyl, and C₁-C₆ alkoxy, and —(CH₂)ₙCO₂H, where n is 1-3,
R₅ is selected from the group consisting of hydrogen and CO₂H,
provided that at least one of R₄ and R₅ is —(CH₂)ₙCO₂H or CO₂H, respectively, and
A is OH or N(Rₐ)(R_{b}), wherein Rₐ and R_{b} are independently selected from hydrogen and C₁-C₆ alkyl.

15. The kit of claim 14, wherein the probe is a hybridization probe.

16. The kit of claim 14, wherein the probe is a hydrolysis probe.

17. A composition, comprising:
(a) a compound having the formula: 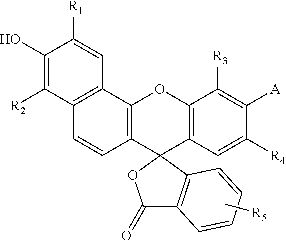
or its active esters, acid/base forms, tautomers, or salts, wherein
R₁ is selected from the group consisting of halo, C₁-C₆ alkyl, C₁-C₆ haloalkyl, and C₁-C₆ alkoxy;
R₂ is selected from the group consisting of hydrogen, halo, C₁-C₆ alkyl, C₁-C₆ haloalkyl, and C₁-C₆ alkoxy;
R₃ is selected from the group consisting of hydrogen, halo, C₁-C₆ alkyl, C₁-C₆ haloalkyl, and C₁-C₆ alkoxy;
R₄ is selected from the group consisting of hydrogen, halo, C₁-C₆ alkyl, C₁-C₆ haloalkyl, and C₁-C₆ alkoxy, and —(CH₂)ₙCO₂H, where n is 1-3, and
R₅ is selected from the group consisting of hydrogen and CO₂H,
provided that at least one of R₄ and R₅ is —(CH₂)ₙCO₂H or CO₂H, respectively; and
A is OH or N(Rₐ)(R_{b}), wherein Rₐ and R_{b} are independently selected from hydrogen and C₁-C₆ alkyl; and
(b) one or more other fluorescent compounds.

18. The composition of claim 17, wherein the fluorescent compound is a seminaphthofluorescein.
